(19) United States
(12) Patent Application Publication
(10) Pub. No.: US 2022/0163165 A1
(43) Pub. Date: May 26, 2022

(54) STABILIZING AND CENTRALIZING AUGER MOTOR BRACKET FOR A PELLET GRILL SYSTEM

(71) Applicants: Robert Stanley Briggs, Red Deer (CA); Terrence Ronald Hall Fitzgerald, Red Deer (CA)

(72) Inventors: Robert Stanley Briggs, Red Deer (CA); Terrence Ronald Hall Fitzgerald, Red Deer (CA)

(21) Appl. No.: 17/104,576

(22) Filed: Nov. 25, 2020

(51) Int. Cl. F16M 7/00; A47J 37/07

(52) U.S. Cl. CPC F16M 7/00; A47J 37/0704

(57) ABSTRACT

A bracket for stabilizing and centralizing an auger motor of a pellet grill/smoker system, comprising a vertical member orthogonally affixed to a horizontal member such that the vertical member and the horizontal member form an L-shaped configuration. The vertical member includes a central hole which allows for an auger shaft of the auger motor to pass through the vertical member and a plurality of fastener holes for securing the vertical member to the auger motor and the horizontal member includes one or more fastener holes for securing the horizontal member to a mounting plate of a hopper assembly.

### FIELD OF THE INVENTION

The present disclosure relates to an auger motor bracket, more specifically but not by way of limitation, an L-shaped auger motor bracket for pellet grill/smoker systems that stabilizes and centralizes the torque from the auger motor to the proper alignment during operation.

### BACKGROUND

C.N. Pub. No. 208,353,110 U (Guo et al.) discloses an electric machine support including angle steel, web, channel steel and connecting rod. Shortcomings include excess material costs, arduous installation and insufficient structural support for long-term, repeated use of an auger motor for a pellet grill system.

U.S. Pat. No. 6,145,803 A (Emody et al.) discloses a quick release motor mount. Shortcomings include excess materials and costs, invasive and arduous installation, and insufficient structural support for long-term, repeated use of an auger motor for a pellet grill system.

U.S. Pat. No. 4,823,684 A (Traeger et al.) discloses a pellet-fired barbecue. Shortcomings include insufficient structural support for long-term, repeated use of an auger motor for the pellet-fired barbecue.

U.S. Pat. No. 2,715,870 A (Rutkowski) discloses a barbecue device. Shortcomings include a time consuming, extensive installation of the track roller frame cleaning mechanism onto a track-type machine and a lack of flow-rate variability for the slider.

U.S. Pat. No. D813,648 S (Karol et al.) discloses a motor bracket design. Shortcomings include an inability to apply this bracket to an auger motor from a pellet grill for complete structural support in the against the hopper assembly.

All documents cited herein are incorporated by reference.

There is a need for an auger motor bracket that stabilizes and centralizes the torque from the auger motor to the proper alignment during operation, that reduces wear and tear on the auger bushing prolonging the lifetime of the auger motor and hopper assembly, that reduces operational noise, that may be manufactured into a pellet grill/smoker or effortlessly retrofitted to an existing pellet grill/smoker, and that helps reduce safety issues and concerns associated with jammed pellets.

### BRIEF SUMMARY

It is the object of the present invention to provide an L-shaped bracket.

In accordance with an aspect of the invention, there is provided a bracket for stabilizing and centralizing an auger motor of a pellet grill/smoker system, comprising a vertical member orthogonally affixed to a horizontal member such that the vertical member and the horizontal member form an L-shaped configuration. The vertical member includes a central hole which allows for an auger shaft of the auger motor to pass through the vertical member and a plurality of fastener holes for securing the vertical member to the auger motor and the horizontal member includes one or more fastener holes for securing the horizontal member to a mounting plate of a hopper assembly which allows for an auger shaft of the auger motor to pass through the vertical member and a plurality of fastener holes for securing the vertical member to the auger motor. The horizontal member includes one or more fastener holes for securing the horizontal member to a mounting plate of a hopper assembly.

In accordance with another aspect of the invention, there is provided a method of retrofitting the bracket from claim 1 onto a pellet grill/smoker, comprising inserting the bracket against the auger motor such that the horizontal member lies in plane with a base of the auger motor and the mounting plate of the hopper assembly and the vertical member lies in plane with a face of the auger motor such that the auger shaft passes through the central hole of the vertical member and applying a plurality of fasteners to the plurality of fastener holes such that the vertical member is securely affixed to the auger motor assembly and the horizontal member is securely affixed to the auger motor and the mounting plate.

In accordance with another aspect of the invention, there is provided a bracket assembly kit, to stabilize and centralize an auger motor of a pellet grill/smoker system, the kit comprising a bracket comprising a vertical member orthogonally affixed to a horizontal member such that the vertical member and the horizontal member form an L-shaped configuration. The vertical member includes a central hole which allows for an auger shaft of the auger motor to pass through the vertical member and a plurality of fastener holes for securing the vertical member to the auger motor. The horizontal member includes one or more fastener holes for securing the horizontal member to a mounting plate of a hopper assembly and a plurality of fasteners.

In accordance with an embodiment of the invention, the bracket is manufactured into a pellet grill/smoker.

In accordance with an embodiment of the invention, the bracket is composed of metal.

In accordance with an embodiment of the invention, the plurality of fastener holes are located along the perimeter of the vertical member and the horizontal member.

In accordance with an embodiment of the invention, an adhesive is applied to the bracket.

In accordance with an embodiment of the invention, the horizontal member lies flush against the base of the base of the auger motor and the mounting plate.

In accordance with an embodiment of the invention, one or more gaps exist between said horizontal member, said base of said auger motor and said mounting plate.

In accordance with an embodiment of the invention, the vertical member lies flush against the face of the auger motor.

In accordance with an embodiment of the invention, a gap exists between the vertical member and the face of the auger motor.

In accordance with an embodiment of the invention, the kit further comprises an adhesive.

In accordance with an embodiment of the invention, the kit further comprises instructions for installation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

There are many complaints about the auger motor of many different pellet grill/smoker models on the market shifting over time such that the auger shaft becomes misaligned and rattles against and damages the mounting plate of the hopper assembly. This problem exists with across a large variety of pellet smoker/grills because due common setup between auger motor and hopper assemblies. The auger is typically located at the bottom of the hopper assembly such that it forces wood pellets slowly towards the fire pot. The shift of the auger assembly over prolonged use can become a safety issue to the operator and to the hopper assembly when the auger is operational.

The bracket, presented hereafter, is employed to stabilize and centralize the torque from the auger motor to the proper alignment during operation, thus reducing wear and tear on the auger bushing, prolonging the lifetime of the auger motor and the hopper assembly, reduces operational noise and safety issues and concerns associated with jammed pellets.

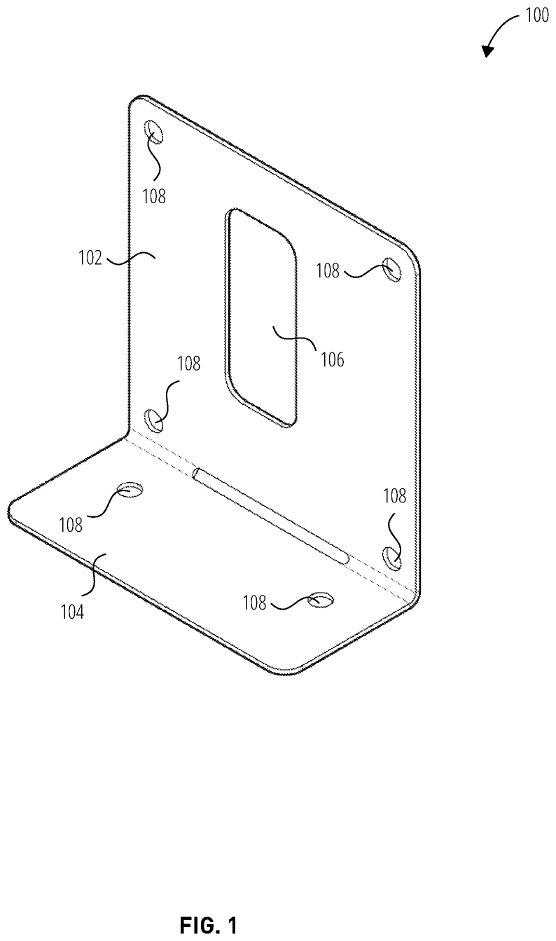

FIG. 1 depicts a perspective view 100 of an L-shaped auger motor bracket of a pellet grill/smoker system as in one embodiment. The bracket employed for stabilizing and centralizing an auger motor of a pellet grill/smoker system, comprises a vertical member 102 orthogonally affixed to a horizontal member 104. The vertical member 102 includes a central hole 106 which allows for an auger shaft from the auger motor to pass through the vertical member 102.

A plurality of fastener holes 108 are shown, which may be employed in combination with a plurality of fasteners for securing the vertical member 102 to the auger motor. Similarly, the horizontal member 104 includes a couple fastener holes 108, which may be employed in combination with a plurality of fasteners for securing the horizontal member 104 to a mounting plate of a hopper assembly. In some embodiments, the plurality of fastener holes 108 are located along the perimeter of the vertical member 102 and the horizontal member 104. In some embodiments, the bracket is manufactured into a pellet grill/smoker. In some embodiments, the bracket is composed of metal.

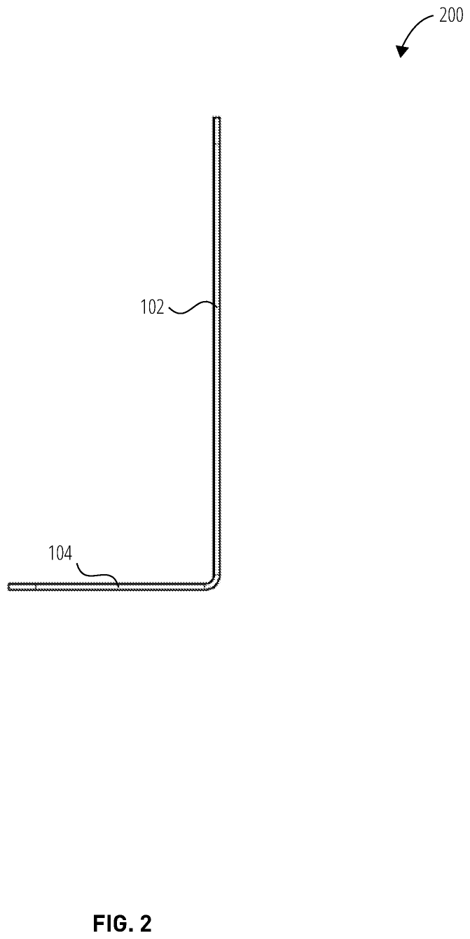

FIG. 2 depicts a side view 200 of the L-shaped auger motor bracket of a pellet grill/smoker system as in one embodiment. The vertical member 102 and horizontal member 104 are shown connected perpendicularly.

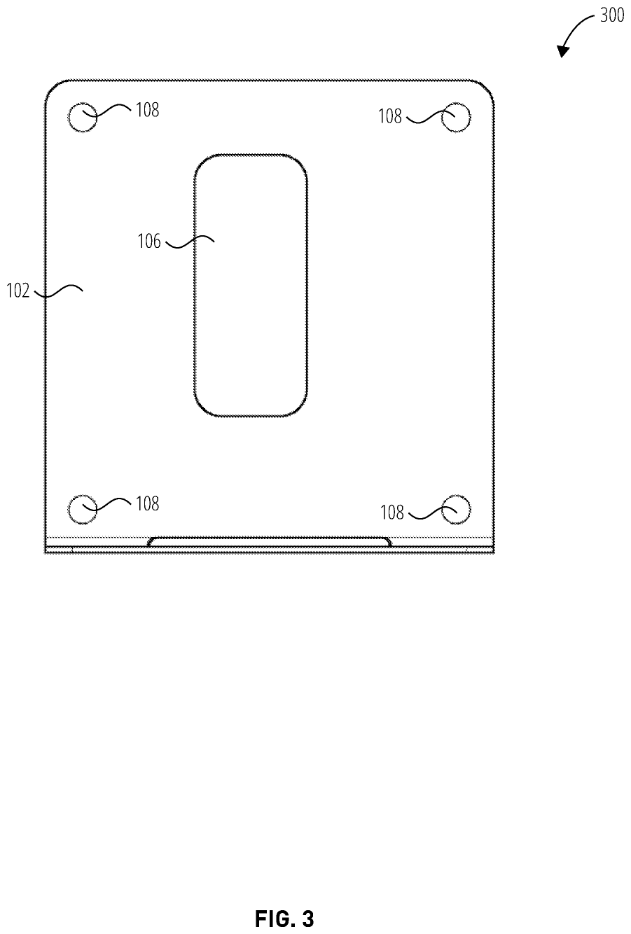

FIG. 3 depicts a front view 300 of the L-shaped auger motor bracket of a pellet grill/smoker system as in one embodiment. The vertical member 102 is shown with four fastener holes 108 at each corner of the vertical member 102 and a central hole 106.

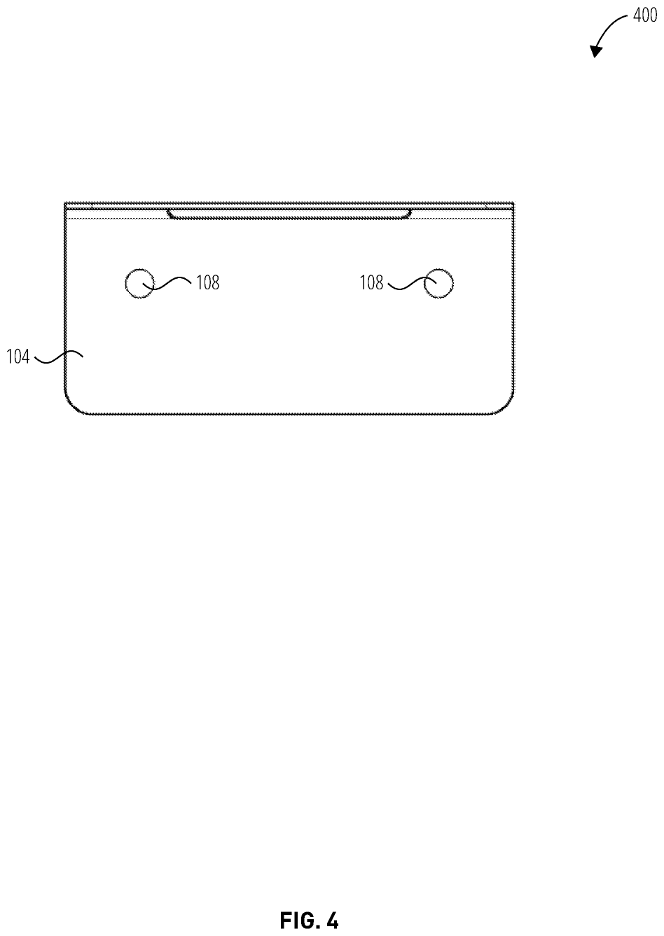

FIG. 4 depicts a base view 400 of the L-shaped auger motor bracket of a pellet grill/smoker system as in one embodiment. The horizontal member 104 is shown with two fastener holes 108.

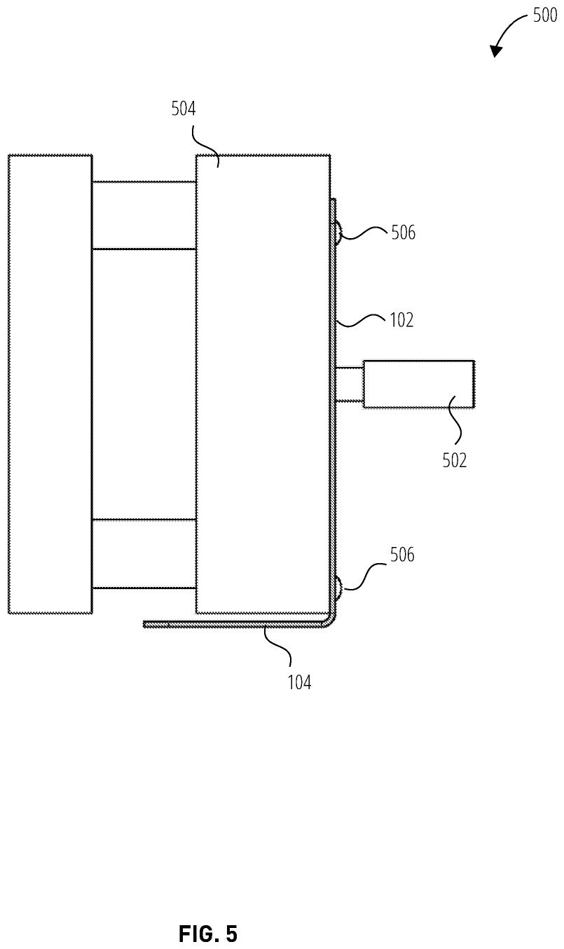

FIG. 5 depicts an applied view 500 of the L-shaped auger motor bracket of a pellet grill/smoker system as in one embodiment. This example displays the bracket assembled to an auger motor assembly 504 of a pellet grill/smoker. The vertical member 102 is shown affixed to the auger motor assembly 504 via a plurality of fasteners 506. An auger shaft receiver 502 shown passing through the vertical member 102 of the bracket.

A method of retrofitting the bracket onto a pellet grill/smoker, comprises inserting the bracket against the auger motor assembly 504 such that the horizontal member 104 lies in plane with a base of the auger motor assembly 504 and a mounting plate of a hopper assembly, not presently shown. In some embodiments, the horizontal member 104 lies flush against the base of the auger motor assembly 504 and the mounting plate, such as in FIG. 5. In other embodiments, one or more gaps exist between the horizontal member 104, the base of the auger motor assembly 504 and the mounting plate.

The vertical member 102 lies in plane with a face of the auger motor assembly 504 such that the auger shaft receiver 502 passes through the central hole 106 of the vertical member 102, as shown in FIG. 5. In some embodiments, the vertical member 102 lies flush against the face of the auger motor assembly 504. In other embodiments, a gap exists between the vertical member 102 and the face of the auger motor assembly 504.

A plurality of fasteners 506 are applied to the plurality of fastener holes 108 form the bracket such that the vertical member 102 is securely affixed to the face of the auger motor assembly 504. Similarly, a plurality of fasteners 506 are applied to the plurality of fastener holes 108 form the L-shaped bracket such that the horizontal member 104 is securely affixed to the face of the base of the auger motor assembly 504 and the mounting plate.

inserting said bracket against said auger motor such that said horizontal member lies in plane a base of said auger motor and said mounting plate of said hopper assembly and said vertical member lies in plane a face of said auger motor such that said auger shaft passes through said central hole of said vertical member; and

Once secured, the L-shaped bracket aids to firmly anchor the auger motor assembly 504 to the mounting plate of the hopper assembly such that proper alignment is maintained during operation. In some embodiments, an adhesive is applied to the L-shaped bracket during assembly to further secure the auger motor assembly 504.

In some embodiments, a bracket assembly kit may be employed to stabilize and centralize an auger motor of a pellet grill/smoker system. The kit comprises a bracket comprising a vertical member 102 orthogonally affixed to a horizontal member 104 such that the vertical member 102 and the horizontal member 104 form an L-shaped configuration. The vertical member 102 includes a central hole 106 which allows for an auger shaft receiver 502 of the auger motor assembly 504 to pass through the vertical member 102 and a plurality of fastener holes 108 for securing the vertical member 102 to the auger motor assembly 504. The horizontal member 104 includes one or more fastener holes 108 for securing the horizontal member 104 to a mounting plate of a hopper assembly and a plurality of fasteners.

In other embodiments, the kit further comprises an adhesive. In some embodiments, the kit further comprises instructions for installation.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A bracket for stabilizing and centralizing an auger motor of a pellet grill/smoker system, comprising:
a vertical member orthogonally affixed to a horizontal member such that said vertical member and said horizontal member form an L-shaped configuration;
said vertical member includes a central hole which allows for an auger shaft of said auger motor to pass through said vertical member and a plurality of fastener holes for securing said vertical member to said auger motor; and
said horizontal member includes one or more fastener holes for securing said horizontal member to a mounting plate of a hopper assembly.

2. The bracket from claim 1, wherein said bracket is manufactured into a pellet grill/smoker.

3. The bracket from claim 1, wherein said bracket is composed of metal.

4. The bracket from claim 1, wherein said plurality of fastener holes are located along the perimeter of said vertical member and said horizontal member.

5. A method of retrofitting said bracket from claim 1 onto a pellet grill/smoker, comprising:
inserting said bracket against said auger motor such that said horizontal member lies in plane with a base of said auger motor and said mounting plate of said hopper assembly and said vertical member lies in plane with a face of said auger motor such that said auger shaft passes through said central hole of said vertical member; and
applying a plurality of fasteners to said plurality of fastener holes such that said vertical member is securely affixed to said auger motor assembly and said horizontal member is securely affixed to said auger motor and said mounting plate.

6. The method according to claim 5, wherein an adhesive is applied to said bracket.

7. The method according to claim 5, wherein said horizontal member lies flush against said base of said base of said auger motor and said mounting plate.

8. The method according to claim 5, wherein one or more gaps exist between said horizontal member, said base of said auger motor and said mounting plate.

9. The method according to claim 5, wherein said vertical member lies flush against said face of said auger motor.

10. The method according to claim 5, wherein a gap exists between said vertical member and said face of said auger motor.

11. A bracket assembly kit, to stabilize and centralize an auger motor of a pellet grill/smoker system, said kit comprising:
a bracket comprising a vertical member orthogonally affixed to a horizontal member such that said vertical member and said horizontal member form an L-shaped configuration;
said vertical member includes a central hole which allows for an auger shaft of said auger motor to pass through said vertical member and a plurality of fastener holes for securing said vertical member to said auger motor;
said horizontal member includes one or more fastener holes for securing said horizontal member to a mounting plate of a hopper assembly and a plurality of fasteners.

12. The kit according to claim 11, wherein said kit further comprises an adhesive.

13. The kit according to claim 11, wherein said kit further comprises instructions for installation.
